(19) United States
(12) Patent Application Publication
(10) Pub. No.: US 2009/0095819 A1
(43) Pub. Date: Apr. 16, 2009

(54) HOT-AIR TYPE HEATER APPARATUS

(76) Inventors: Carl Brown, Tokyo (JP); Akio Goto, Tokyo (JP)

Correspondence Address: STETINA BRUNDA GARRED & BRUCKER, 75 ENTERPRISE, SUITE 250, ALISO VIEJO, CA, 92656, US

(21) Appl. No.: 12/014,427

(22) Filed: Jan. 15, 2008

(30) Foreign Application Priority Data
Oct. 15, 2007 (JP) 2007-268034

(51) Int. Cl. F24D 13/00; H05B 3/10; H05B 3/00

(52) U.S. Cl. 237/81; 219/444.1; 392/403; 392/394

(57) ABSTRACT

A hot-air type heater apparatus includes an air intake for receiving air from an area to be heated by the hot-air type heater apparatus. In particular, the air intake includes a suction fan for drawing air from a surrounding area into the hot-air type heater apparatus. The air from the surrounding area enters the hot-air type heater through the air intake. The hot-air type heater also includes an air passage to direct the air received from the air intake to a ceramic heater. The air passage allows the air received from the air intake to flow into the ceramic heater. The ceramic heater is then able to rapidly increase the air temperature. Furthermore, the hot-air type heater includes a warm air outlet coupled to the ceramic heater. The warm air outlet outputs the air heated by the ceramic heater into the area to be heated by the hot-air type heater apparatus.

### CROSS-REFERENCE TO RELATED APPLICATIONS

The present application claims priority to Japanese application no. 2007-268034 filed Oct. 15, 2007 entitled A Hot-Air Type Heater Apparatus.

### STATEMENT RE: FEDERALLY SPONSORED RESEARCH/DEVELOPMENT

NOT APPLICABLE

### BACKGROUND

1. Technical Field

The present invention relates to a heating apparatus and, more particularly, to a hot-air type heater apparatus that utilizes a positive temperature coefficient (PTC) ceramic heating element as a heat source.

2. Related Art

A conventional hot-air type heater utilizes, for example, a combustion method in which the air needed for combustion is taken from outside of the area to be heated. The air drawn from outside is then combusted in an enclosed combustion area. As a result, vapor and combustion exhaust are emitted outside the area to be heated, while the heater directs only warm air into the area to be heated. Another well known heater in the art is a petroleum oil fan heater. The oil fan heater intakes air from inside of an area to be heated. The air is then heated within the heater by combusting petroleum oil. The warm air is then returned to the area to be heated.

However, because air needed for combustion is taken from outside the area to be heated, the air intake and vapor/combustion exhaust outlet are required to be located outside the area to be heated. Thus, the air intake and vapor/combustion exhaust outlet must be built on an outside wall of the structure or home that is to be heated. Therefore, the hot-air type heater apparatus must be placed alongside the outside wall as well. The installation and operation may prove problematic, as additional piping and other fittings may be required. Piping heated air may increase the risk of leaks and/or malfunctions. Additionally, the operation cost of the hot-air type heater apparatus is increased when installed outside of the area to be heated.

Also, in the petroleum oil fan heater, room ventilation is required to avoid Carbon Monoxide (CO) poisoning due to incomplete combustion while consuming oxygen in a room.

There exists a need in the art for a lightweight hot-air type heater apparatus that is easy to install, operates similar to existing hot-air type heaters while reducing operational costs. Additionally, there exists a need in the art for a hot-air type heater that does not consume oxygen from the area to be heated, does not require room ventilation, and is capable of delivering clean warm area into a room, house, or general area to be heated.

### BRIEF SUMMARY

Briefly, and in general terms, the present invention resolves the above and other problems by providing a hot-air type heater apparatus. The hot-air type heater apparatus includes an air intake for receiving air from an area to be heated by the heater apparatus. In particular, the air intake includes a suction fan for drawing air from a surrounding area into the hot-air type heater apparatus. The air from the surrounding area enters the hot-air type heater through the air intake. The hot-air type heater also includes an air passage to direct the air received from the air intake to a ceramic heater. The air passage allows the air received from the air intake to flow into the ceramic heater. The ceramic heater is then able to rapidly increase the air temperature. Furthermore, the hot-air type heater includes a warm air outlet coupled to the ceramic heater. The warm air outlet outputs the air heated by the ceramic heater into the area to be heated by the hot-air type heater apparatus.

In accordance with another embodiment of the present invention, the warm air outlet may also include a thermal conductive plate or plates. An aspect of the present invention contemplates the thermal conductive plates being made out of copper.

In yet another embodiment of the present invention, the hot-air type heater further includes a water tank. Additionally, the hot-air type heater includes a humidification device. Located on a top surface of the hot-air type heater is a humidification nozzle. The water tank is in communication with the humidification device for emitting moisture or vapor from the humidification nozzle of the hot-air type heater.

Additionally, an aspect of the present invention contemplates a multi-layered structure of outer and inner plates constructed within the hot-air type heater apparatus. The outer and inner plates are constructed such that they effectively shield the outer surface of the hot-air type heater apparatus from conducting heat. If the apparatus is overturned, the outer and inner plates protect the outer surface of the heater from conducting heat and reaching ignition temperature. Therefore, there is no risk of fire and the apparatus can be used safely. Also, it is contemplated that the hot-air type heater apparatus includes a plurality of castors for allowing the heating apparatus to be easily maneuverable. In another embodiment of the present invention, the ceramic heater is comprised of a plurality of ceramic plates that have a positive temperature coefficient. The ceramic plates are coupled to each other to form a plurality of ceramic plate layers.

The hot-air type heater apparatus of the present invention includes the ceramic heater that heats intake-air and outputs warm air through a passage of warm air. As a result, the heater apparatus does not require installation similar to conventional hot-air type heater apparatuses. Additionally, the cost of operation is reduced because air being drawn into the heater is from the area to be heated and not from outside. Thus, the hot-air type heater apparatus does not consume oxygen within a room. The heater also does not require room ventilation and can send clean warm air into the room. Furthermore, since the hot-air type heater apparatus is equipped with the thermal conductive plates, this effectively prevents the warm air passage from cooling significantly. Also, since the thermal conductive plates are made of copper (plate), the air heated by the ceramic heater contacts the copper plate, generating far-infrared radiation. Therefore, radiant heat due to the far-infrared radiation effect is emitted into a room, heating the room uniformly.

In accordance with the present invention, there is also provided a method for heating a room. The method includes receiving air from the room to be heated. The air is received through an air intake. The air intake also includes a suction fan for drawing air into a heating apparatus. The method further includes directing the air drawn in from the suction fan to a ceramic heater by way of an air passage. The air is then heated by the ceramic heater and outputted into the room through a warm air outlet. It is also contemplated that the warm air outlet includes a plurality of thermal conductive plates. The plates may be made of copper. The method may further include a humidifier for emitting vapor into the room simultaneous to the air being outputted by the warm air outlet. The humidifier may include a nozzle on the top outer surface of the heater apparatus. In one embodiment of the present invention, the method includes a multi-layered structure of outer and inner plates constructed in a way to prevent the outer surface of the heater apparatus from conducting heat.

Other features and advantages of the present invention will become apparent from the following detailed description, taken in conjunction with the accompanying drawings, which illustrate by way of example, the features of the present invention.

### BRIEF DESCRIPTION OF THE DRAWINGS

FIG. 1 is a front perspective view illustrating the structure of the hot-air type heater apparatus;

FIG. 2 is a rear perspective view illustrating the structure of the hot-air type heater apparatus;

FIG. 3 is a front view illustrating the control panel;

FIG. 4 is a perspective illustrating the inner structure of the hot-air heater apparatus;

FIG. 5 is a perspective view illustrating the inside structure of the suction fan area of the hot-air type heater apparatus;

FIG. 6 is a perspective view illustrating the inside structure of the air passage, the ceramic heater, and the passage of warm air of the hot-air type heater apparatus; and

FIG. 7 is a perspective view illustrating the inside structure of the ceramic heater and the warm air outlet of the hot-air type heater apparatus.

### DETAILED DESCRIPTION

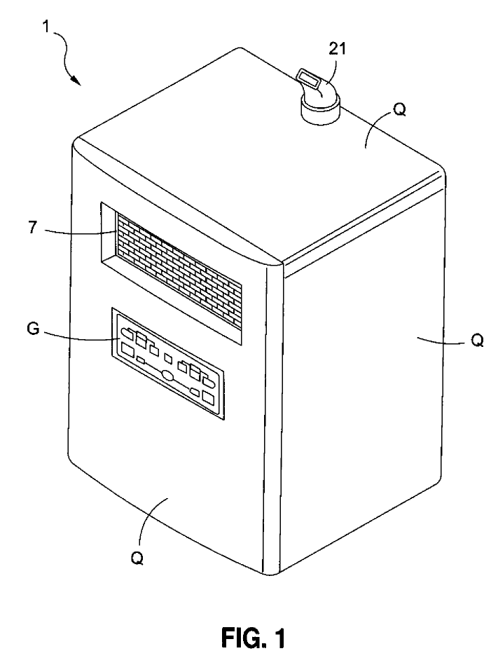

An embodiment of the hot-air type heater apparatus, constructed in accordance with the present invention is shown in FIG. 1. The hot-air type heater apparatus 1 of the present invention may be in the shape of a box. As will be recognized, it is not necessary for the heater apparatus 1 to be in the shape of a box or rectangle. The shape of the hot-air type heater apparatus may include any shape that facilitates heating. The hot-air type heater apparatus 1 includes a double-layered structure formed from outer and inner plates. The outer and inner plates of the double-layered structure are in place to prevent heat conducted within the hot-air type heater apparatus 1 from thermally conducting a surface of the hot-air type heater apparatus 1.

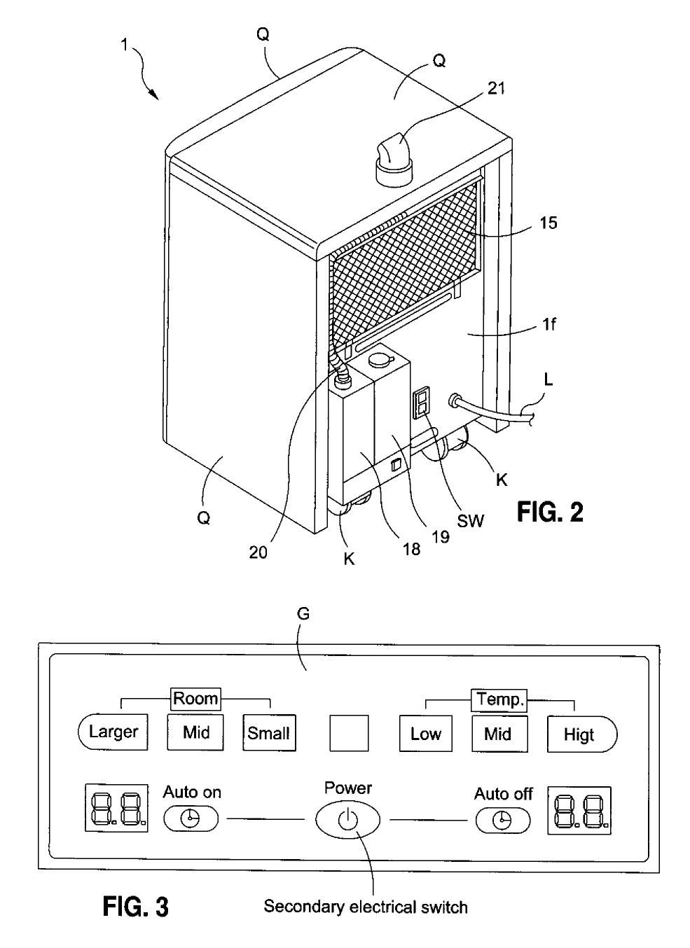

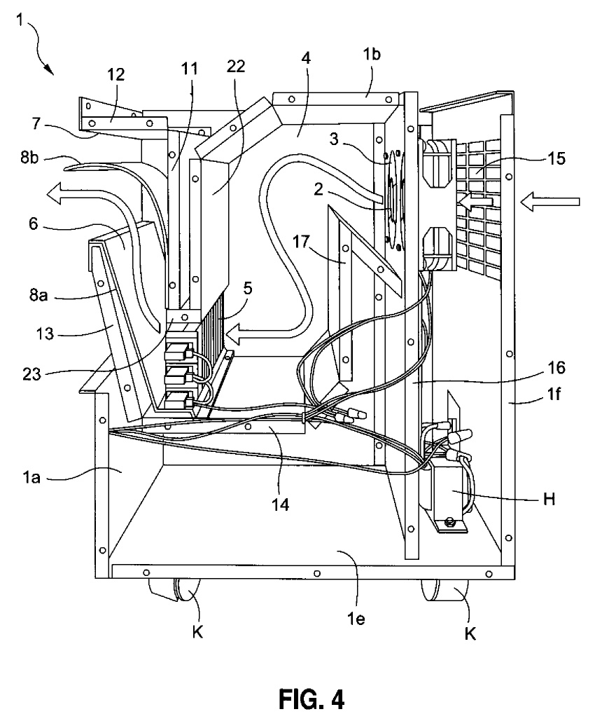

Referring now to the hot-air type heater apparatus 1, as shown in FIGS. 2 and 4, the hot-air type heater apparatus 1 is constructed from an outer plate material 26, a front wall 1a, a top wall 1b, a bottom wall 1e, and a back wall 1f. Attached to the bottom wall 1e are four castors 32 which enable the heater apparatus 1 to be easily pushed to and from a particular area. Furthermore, on the front surface of the box-shaped hot-air type heater apparatus 1, there is a control panel 28 that provides a secondary power switch, three air volume control buttons (i.e. large, medium, and small), three temperature control buttons (i.e. high, medium, and low), and two buttons for setting a timer to turn on/off automatically and two display panels that are arranged symmetrically, etc., as shown in FIGS. 1 and 3.

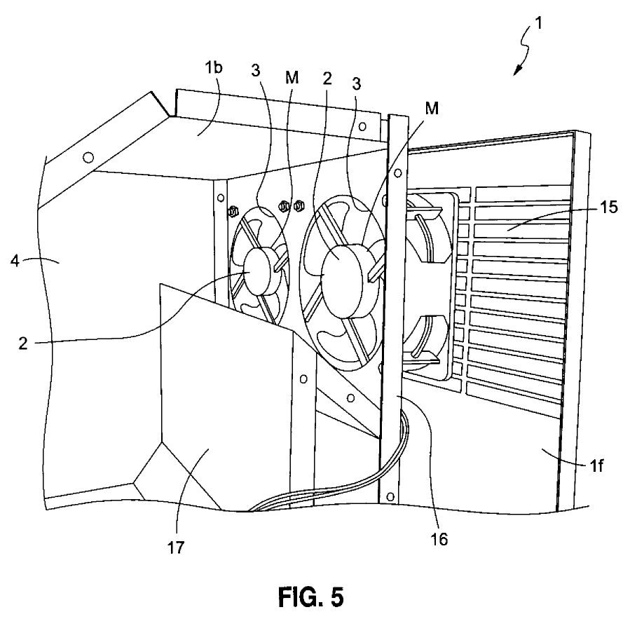

Referring again to FIG. 2, a main electrical switch 34 is provided on the back surface of the hot-air type heater apparatus 1. Additionally, a cable 30 for receiving electrical power is provided at the back surface of the hot-air type heater apparatus 1. It is contemplated that cable 30 is part of the main electrical switch 34. Referring back to FIG. 4, the double-layered structure within the hot-air type heater apparatus is illustrated. The outer plate 26 of the hot-air type heater apparatus 1 may be constructed from materials such as wood, plastic, etc. The examples provided for materials available for the outer plate are by way of example only and are not limiting. Also, as shown in FIGS. 4 and 5, the hot-air type heater apparatus 1 includes a suction opening 15 having lattice-shaped openings provided on the upper part of the back wall 1f. In one embodiment of the present invention, the suction opening 15 is a vent for allowing air from outside of the heater apparatus 1 within the outer plate 26. Additionally, an inner wall plate divider 16 is provided adjacent to the inner portion of the back wall 1f. There exists an arbitrary amount of space between the back wall 1f and the adjacent inner wall plate divider 16. Also, a plurality of air intakes 3 is provided on the upper portion of the inner wall plate divider 16. The plurality of air intakes 3 face the suction opening 15 on the upper part of the back wall 1f.

The upper portion of the inner wall plate divider 16 also includes a plurality of fan motors 38. The fan motors 38 include a suction fan 2 disposed within the air intakes 3. As such, air is drawn and received by the air intakes 3. For example, the suction fan 2 operates to draw air from outside the outer plate 26, through the suction opening 15 and through the air intake 3 thereby allowing air to flow away from the suction opening 15 and past the inner wall plate divider 16. Although a plurality of fan motors 38 are depicted, those having ordinary skill in the art will recognize that one or more fan motors 38 are contemplated herein. Within the hot-air type heater apparatus 1, a roughly reversed L-shaped wall plate 17 is connected to the inner portion of the inner wall plate divider 16. In particular, the reversed L-shaped wall plate 17 may be coupled to the portion of the inner wall plate divider 16 facing away from the suction opening 15. The wall plate 17 is disposed on the inner wall plate divider 16 such that it is directly below the air intakes 3. Also, the top wall 1b is above the wall plate 17 and, on the front end of the top wall 1b, the sidewall 22 is placed in a bent shape in front of the wall plate 17. Furthermore, a lower horizontal wall 14 is also disposed in a bent manner on the lower end of the wall plate 17. An air passage 4 is formed by the top wall 1b, the sidewall 22, the wall plate 17 and the lower horizontal wall 14. The air received from the air intakes 3 follows the path provided by the air passage 4. Because the wall plate 17 has roughly the shape of an upside down L, the air received from the air intakes 3 rises within the air passage 4. However, as the air flows through the air passage 4, the bent shape of both the sidewall 22 and the lower horizontal wall 14 provide an air passage 4 that causes the air to flow downward after flowing past the wall plate 17.

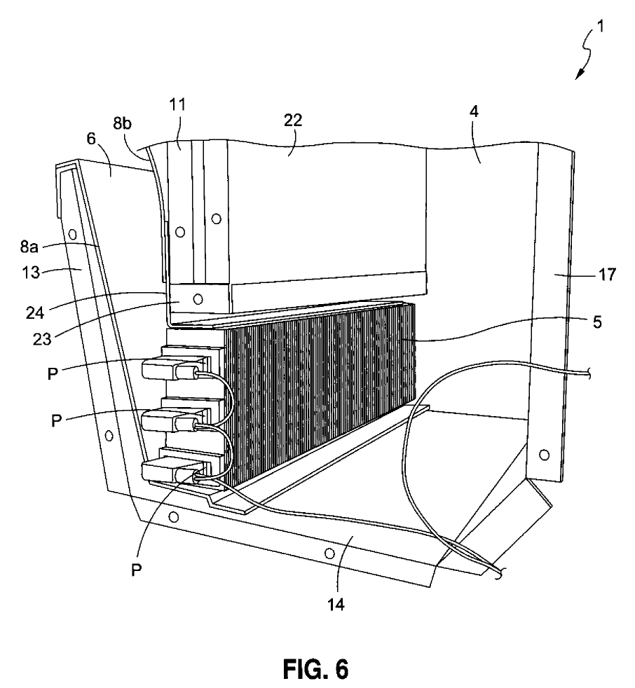

Referring now to FIG. 6, the bottom surface of the sidewall 22 within the air passage 4, includes a connection device 23. Below the bottom portion of the connection device 23 and between the lower horizontal wall 14 there is a horizontal opening wherein the ceramic heater 5 utilizing materials that have a positive temperature coefficient (PTC). As the temperature of the ceramic heater rises, the resistance increases, reducing the current flow and thereby protecting electrical equipment vulnerable to increased current flow. As such the PTC ceramic heating element works as its own thermostat, switching off the current when reaching a maximum temperature. The ceramic heater 5 utilizing PTC as a heat source is attached to the connection device 23 and a rear vertical wall 11 by an angled member 24 in the horizontal opening. The angled member 24 is formed by bending a rectangular shaped plate into an L-shape.

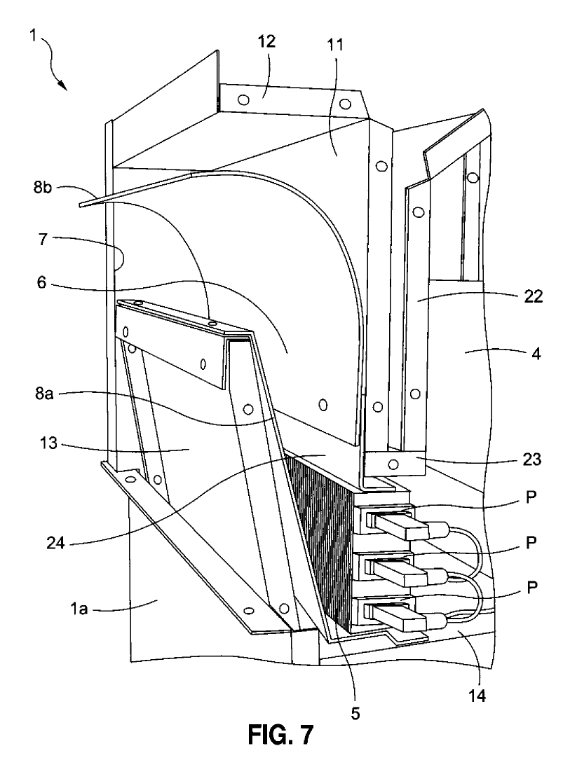

Furthermore, as shown in FIG. 7, a warm air passage 6 is formed. The warm air passage 6 is narrow as the heated air leaves the ceramic heater 5. As warm air flows away from the ceramic heater 5 through the warm air passage 6, the passage 6 increases in width. The warm air passage 6 is formed inside the rear vertical wall 11 attached to the connection device 23 that is placed on the upper part of the ceramic heater 5. The warm air passage 6 is also formed by a top horizontal wall 12 projecting forward from the top end of the rear vertical wall 11 and a front inclined wall 13 forming the front wall. The angled member 24 attaches the ceramic heater 5 to the vertical portion of the connection device 23 and the rear vertical wall 11. The horizontal portion of the rear vertical wall 11 attaches to the top end of the ceramic heater 5 by way of the angled member 24.

Referring again to FIG. 6, because the front end of the lower horizontal wall 14 is connected to the bottom end of the front inclined wall 13, the air passage 4 and the warm air passage 6 are connected through the ceramic heater 5. An aspect of the present invention contemplates the ceramic heater 5 dividing the air passage 4 from the warm air passage 6. Furthermore, as shown in FIGS. 1 and 4, the warm air outlet 7 sends warm air into a room through the warm air passage 6. The warm air outlet 7 is provided on the upper part of the front wall 1a. The warm air outlet 7 is positioned on the upper opening of the outer plate material 26, attached to the front wall 1a. Also, as shown in FIGS. 4 and 7, thermal conductive plates 8a and 8b are placed on the inner wall of the warm air passage 6. Thermal conductive plate 8a is disposed on the inner portion of the front inclined wall 13 facing toward the ceramic heater 5. A portion of the thermal conductive plate 8b is disposed upon the rear vertical wall 11. The thermal conductive plate 8b may also include a shaped curvature, curving away from the rear vertical wall 11. In one embodiment of the present invention, a copper plate is used for the thermal conductive plates 8a and 8b. However, other materials are also contemplated.

The bottom thermal conductive plate 8a is placed along the front inclined wall 13. As shown in FIG. 6, the bottom part of the bottom thermal conductive plate 8a is coupled to the bottom part of the ceramic heater 5 by bending the thermal plate 8a horizontally, enabling the heat of the ceramic heater 5 to conduct the thermal conductive plate 8a. The top end part of the horizontally bent part of the thermal conductive plate 8a is further bent downward and is attached to the bottom horizontal wall 14. Also, the upper part of the thermal conductive plate 8a is bent and is attached to and engaged with the front inclined wall 13. The top thermal conductive plate 8b is placed along the rear vertical wall 11 and the top horizontal wall 12. As shown in FIG. 7, the whole top thermal conductive plate 8b is curved in order to be spaced between the rear vertical wall 11 and the top horizontal wall 12. Also, the bottom base part of the thermal conductive plate 8b is coupled to the vertical part of the angled member 24 and the heat of the ceramic heater 5 is conducted to the thermal conductive plate 8b via the angled member 24.

A horizontally long oblong opening is formed between the front end of the top horizontal wall 12 and the top end part of the front inclined wall 13, forming the warm air outlet 7. An aspect of the present invention contemplates barium titanate ceramic with additives as the PTC material used for the ceramic heater 5. The use of barium titanate results in rapid increase of electrical resistance near Curie temperature. As a result, the current flow slows due to the self-heating, or Joule heat, when the current is kept flowing; thus, constant temperature can be kept and the apparatus can be used as a non-polluting heater.

In accordance with the present invention the specific structure of this ceramic heater 5, as shown in FIGS. 6 and 7, includes ceramic material that is processed into plates. The plates are then piled or stacked against each other to form a plurality of layers. Three electrode-connecting terminals 36 of insertion-type plugs conduct the current into the plurality of ceramic plates at one end of the layered plates. An air blower mechanism may also be included with the ceramic heater 5. For example, an electrical transformer 40 is placed between the back wall 1f and the inner wall plate divider 16. The transformer 40 provides two ceramic heaters 5 with a 180 degree phase shifting wavelength waveform electricity. The electrical transformer 40 controls the current flow rate. The heat generated in the ceramic heater 5 is sent out by operation of the suction fan 2 as warm air. The control of the current flow rate by the supply of waveform electricity is one example of this present invention and it goes without saying that other types of current flow rate controls can be used. Thus, by controlling the current flow rate at the ceramic heater 5, and by keeping the constant volume of warm air flow, it is possible to control electrical energy to the ceramic heater 5.

Also, air volume drawn in by the suction fan 2 may be increased or decreased by controlling the number of rotations of the fan motor 38 that drives the suction fan 2. The number of rotations of the fan motor 38 is controlled by adjusting the applied voltage. Furthermore, the hot-air type heater 1 is equipped with a thermostat (not shown) that prevents drastic rise of a temperature inside the hot-air type heater apparatus 1. The thermostat may be located on the inside of the hot-air type heater apparatus 1, for example, in between the back wall 1f and the inner wall plate divider 16. A safety shutoff device may also be included (not shown in Fig.), etc., that automatically shuts power down when the hot-air type heater apparatus 1 is turned over.

Also, the hot-air type heater apparatus 1 has a humidification mechanism. Specifically, as shown in FIG. 2, the water tank 19 is provided adjacent the main electrical switch 34 on the back surface of the hot-air type heater apparatus 1. Also, the humidification device 18 is placed next to the water tank 19. Furthermore, a humidity-generating nozzle 21 is provided on the top surface of the hot-air type heater apparatus 1. The humidification device 18 and the humidity-generating nozzle 21 are connected through an accordion pipe 22. The humidification device 18 may connect to the humidity-generating nozzle 21 through other means as well. When heated air is outputted from the warm air outlet 7, the water tank 19 may provide water to the humidification device 18 to generate water vapor to be emitted from the top surface of the hot-air type heater apparatus 1 by the humidity-generating nozzle 21. Thus, it is contemplated that the humidifier may function simultaneous to the heating of air by the ceramic heater 5 and serves to increase the efficiency of the heater apparatus.

In one embodiment of the present invention, the hot-air type heater apparatus 1 is moved to a desired position in a room using the casters K. Next, the main electrical switch 34 located on the back surface of the hot-air type heater apparatus 1 is switched to the on position. The various parameters are then set, including the volume of air, temperature, timer, etc., using the control panel 28 located on the front surface. Then, a secondary electrical switch is turned on via the control panel 28. The secondary electrical switch allows for an electrical signal to turn the fan motor 38 located on the back wall of the hot-air type apparatus 1 on. As the fan motor 38 turns on, the suction fan 2 starts to rotate. Air is then received through the suction opening 15 and continues to flow through to the air passage 4 via the air intakes 3 on the upper part of the inner wall plate divider 16 on the back wall 1f. Furthermore, the secondary switch may also control the humidification device 18 of the hot-air type heater apparatus 1. When the humidification device 18 is operating, water from the water tank 19 is emitted from the humidity generating nozzle 21 in the form of mist or vapor.

A current is provided to the ceramic heater 5 utilizing PTC material for increased resistance. The current is provided via the electrode connecting terminals 36. As a result, the ceramic heater may quickly increase in temperature from the current supply. The ceramic heater 5 is disposed near the lower part of the air passage 4. The electrode connecting terminals 36 deliver power to the ceramic heater 5. After the air enters the air passage 4, it is heated by the ceramic heater 5. The ceramic heaters 5 temperature is dependent upon the electricity flow supplied by the electrode connecting terminals 36. Thus, heat is generated by controlling the electricity flow rate by supplying half-wavelength waveform electricity, including 180 degree phase shifting to the ceramic heaters 5. The air is heated as it flows through the ceramic heaters 5. Then the heated air continues flowing through the warm air passage 6 as the passage 6 increases in width toward the warm air outlet 7. It is important to note that the flow of air from the air intakes 3 through the ceramic heaters 5 and onward to the warm air outlet 7 is caused by the rotation of the suction fan 2. The air now warm, is sent out into the room from the warm air outlet 7 located on the upper part of the front surface of the hot-air type heater apparatus 1.

To maintain the warm air passage 6, the thermal conductive plates 8a and 8b are made of copper. The ability of copper as a thermal conductor is superior to most materials. The copper is provided on the inside wall of the warm air passage 6. The copper plates 8a and 8b extend from the ceramic heater 5 to the warm air outlet 7. As a result, the warm air flowing from the ceramic heater 5 is not cooled as it flows through the warm air passage 6 and out of the warm air outlet 7. Additionally, because the thermal conductive plates 8a and 8b are made of copper (plate), the air heated by the ceramic heater 5 contacts the copper plates, enabling the generation of far-infrared radiation. Therefore, radiant heat emitted due to the far-infrared radiation effect, warms the room uniformly. Also, since the humidity-generating nozzle 21 on the top surface of the hot-air type heater apparatus 1 generates vapor, the humidity level in the room during the heater apparatus 1 use is increased. Also, the vapor helps increase air temperature of the entire room. In another embodiment of the present invention, the thermal conductive plates 8a and 8b are made from a material with thermal conductivity characteristics similar to copper.

The hot-air heater type apparatus of the present invention can be widely used as a heating apparatus having various structures utilizing a ceramic heater as a heat source.

What is claimed is:

1. A hot-air type heater apparatus, comprising:
an air intake for receiving air from an area to be heated, the air intake having a suction fan for drawing air into the hot-air type heater apparatus;
an air passage for directing air received from the air intake to a ceramic heater, for increasing air temperature; and
a warm air outlet coupled to the ceramic heater for outputting heated air into the area to be heated.

2. The apparatus of claim 1, wherein the warm air outlet includes a thermal conductive plate.

3. The apparatus of claim 2, wherein the thermal conductive plate is made of copper.

4. The apparatus of claim 1, further comprising:
a water tank;
a humidification device; and
a humidification nozzle on a top surface of the hot-air type heater for increasing moisture to the area to be heated by the hot-air type heater.

5. The apparatus of claim 1, wherein a multi-layered structure of outer and inner plates are constructed to prevent a surface of the hot-air type heater from conducting heat.

6. The apparatus of claim 1, wherein attached to a bottom wall of the hot-air type heater are a plurality of casters for enhanced mobility.

7. The apparatus of claim 1, wherein the ceramic heater is comprised of a plurality of ceramic plates having a positive temperature coefficient, the plurality of ceramic plates are coupled together to form a plurality of layers.

8. The apparatus of claim 1, further comprising a humidifier for emitting vapor into a room to be heated by the hot-air type heater apparatus.

9. A method for heating a room, the method comprising:
receiving air from the room through an air intake, the air intake having a suction fan for drawing air into a heating apparatus;
directing air drawn from the air intake to a ceramic heater through an air passage; and
outputting heated air from the ceramic heater into the room through a warm air outlet.

10. The method of claim 9, wherein the warm air outlet includes a thermal conductive plate.

11. The method of claim 9, wherein a humidifier emits vapor into the room as heater air is outputted from the warm air outlet.

12. The method of claim 9, wherein a multi-layered structure of outer and inner plates are constructed to prevent an outer surface of the heating apparatus from conducting heat.

13. The method of claim 9, wherein the ceramic heater is comprised of a plurality of ceramic plates having a positive temperature coefficient, the plurality of ceramic plates being coupled together to for a plurality of layers.
